(19) United States
(12) Patent Application Publication
(10) Pub. No.: US 2009/0173710 A1
(43) Pub. Date: Jul. 9, 2009

(54) CHASSIS FOR A CABLE OR PIPELINE TROLLEY

(76) Inventor: Bernd Maier, Schliengen (DE)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/162,634

(22) PCT Filed: Dec. 2, 2006
(86) PCT No.: PCT/EP2006/011578

§ 371 Date: Nov. 14, 2008

(30) Foreign Application Priority Data
Feb. 2, 2006 (DE) 10 2006 004 721.4

(51) Int. Cl. B66C 11/06

(52) U.S. Cl. 212/346

(57) ABSTRACT

The invention relates to a chassis (1) for a cable or pipeline trolley (2), for travelling along a carrier rail, said chassis comprising at least one pair of carrier rollers (3) with a horizontal rotational axis and at least one pair of guide rollers (4) with a vertical rotational axis. The disadvantage of known chassis of this type is that they jolt at uneven sections of the carrier rail and a significant supply of replacement parts is required for repairs. The aim of the invention is to develop a chassis with improved driving characteristics, whilst at the same time reducing production and inventory costs. To achieve this, the carrier rollers (3) and guide rollers (4) are essentially arranged asymmetrically to a vertical axis (5).

The invention relates to a chassis cable or pipeline trolley for movement along a carrier rail according to the preamble of Claim 1, as well as to a cable or pipeline trolley equipped with such a chassis.

A cable or pipeline trolley that contains such a chassis is the subject matter of DE 44 36 520 C1 and DE 44 36 519 C2 as well as DE 26 28 112 C2. Corresponding cable or pipeline trolleys are found, for instance, in line-laying devices or for crane booms, that is, for all applications in which power-carrying or gas-carrying lines must be led along a rail to a movable load, e.g., the traveler of a crane. The above-mentioned publications describe both passive cable or pipeline trolleys, i.e., those without power of their own, and active cable or pipeline trolleys, i.e., those with their own power.

Cable or pipeline trolleys consist as a rule of three main elements, namely, one or more chasses, the middle part or middle plate and the actual suspension device for the lines to be transported. As a rule, the chasses are suspended from double T-shaped carrier rails, also referred to as I-beams. On the underside of the chassis, the carrier plate is mounted, on which in turn the actual suspension device for the lines to be transported is mounted. As a rule, a cable or pipeline trolley is equipped with two chasses, or with one chassis consisting of two side panels, each having a pair of carrier rollers that move on the carrier rail opposite one another and with a substantially horizontal axis of rotation, and absorb the weight forces. Every chassis further comprises a pair of opposing guide rollers with a substantially vertical axis of rotation, which are dimensioned thinner than the carrier rollers since they need not absorb the weight of the cable or pipeline trolley, but serve only for guidance along the vertical central leg of the I-shaped carrier rail. In all known chasses for cable or pipeline trolleys, one carrier roller and one guide roller is arranged on each carrier plate, and the two carrier plates are bolted together. For reasons of symmetry, each carrier plate must be constructed mirror-symmetrically with respect to the other carrier plate, so that two different carrier plates, namely, a left one and a right one, must be manufactured and kept in stock.

Chasses for cable or pipeline trolleys known from prior art have the further disadvantage that they jolt in case of uneven spots in the carrier rail because both carrier rollers pass the uneven spot at the same time. Moreover, the guidance of these known chasses on the carrier rail is not optimal since the guide rollers must be arranged offset to the carrier rollers.

Therefore the problem exists of refining a chassis for a cable or pipeline trolley, as well as cable or pipeline trolley equipped with such a chassis, in such a manner that better travel properties are achieved, wherein a cost reduction for manufacturing and storage should likewise take place.

This problem is solved with the characterizing features of Claim 1. Advantageous configurations can be deduced from the subordinate Claims 2 and 3. A cable or pipeline trolley equipped with a chassis according to the invention from Claim 4.

An embodiment of the invention will be described in detail below with reference to the accompanying drawings. They show:

FIG. 1: a side view of a cable or pipeline trolley with two chasses according to the invention;

FIG. 2: a front view of the cable or pipeline trolley represented in FIG. 1;

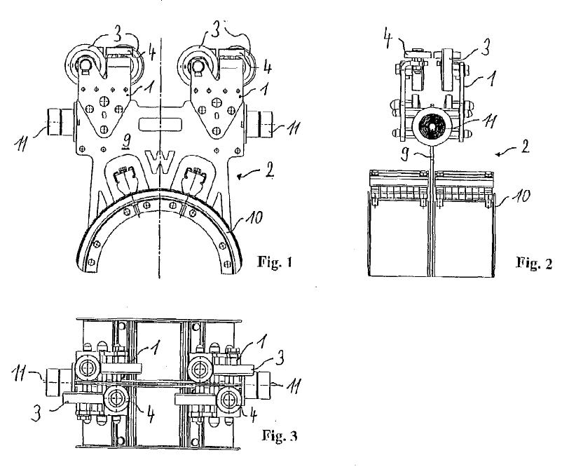

FIG. 3: a top view of the cable or pipeline trolley represented in FIGS. 1 and 2;

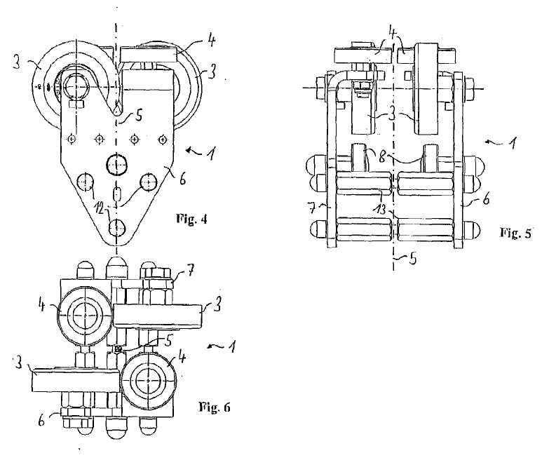

FIG. 4: a chassis as used in the cable or pipeline trolley represented in FIGS. 1-3;

FIG. 5: a representation of the chassis according to FIG. 4 from the front;

FIG. 6: a representation of the chassis according to FIGS. 4 and 5 from above.

Cable or pipeline trolley (2) represented in FIGS. 1-3 consists of a middle part or middle plate (9) that connects two chasses (1) to a carrier device (10) for the electricity and/or gas lines (not shown) to be transported. At the opposite ends in the direction of travel, center plate (9) comprises cell bumpers (11), which have a damping effect in case of collision of adjacent cable or pipeline trolleys and form a collision bumper. On its upper side, center plate (9) in the illustrated embodiment 2 has chassis (1) arranged one after the other in the direction of travel. These chasses (1) are constructed identically and are shown in detail in FIGS. 4-6.

Each chassis (1) has two opposing carrier plates (6) and (7) made of steel or of a suitable plastic that, as viewed from above, are formed tapering down towards the bottom and have several connecting boreholes (12) in their lower areas, through which threaded fasteners (13) are run in order to connect the two carrier plates (6) and (7) to one another, as can be seen most clearly from FIG. 5. At their upper area, the two carrier plates (6) and (7) each bear a carrier roller (3) with a substantially horizontal axis of rotation and a guide roller (4) with a substantially vertical axis of rotation.

However, the two carrier rollers (3) are not arranged opposing one another in the bolted-together state of the two carrier plates (6) and (7), nor are guide rollers (4). Instead, left carrier roller (3) opposes right guide roller (4) and right carrier roller (3) opposes left guide roller (4), as is visible in FIGS. 4-6, particularly in FIG. 6. In contrast to the chassis known from prior art, the arrangement of carrier and guide rolls (3) and (4) is thus not mirror-symmetrical to a plane along the carrier rail (not shown), but rather is axially symmetrical to a vertical axis (5) situated roughly in the center of chassis (1).

As is visible from FIGS. 4-6, the two carrier plates (6) and (7) can be constructed identically to one another. In other words, there is no longer a difference between left carrier plate (6) and right carrier plate (7); these are completely interchangeable individual parts, which also need only be kept in storage as one part.

In the example represented, chassis (1) has additional support rollers, or backing rollers, (8), which have a substantially horizontal axis of rotation and are arranged on carrier plates (6) and (7). These serve to protect chassis (1) from lifting off of the carrier rail.

The chassis of the invention also has considerable advantages in operation with respect to chassis known from prior art. Since the carrier rollers (3) are not arranged facing one another, but rather are offset in the direction of travel, uneven spots of the carrier profile are much more easily absorbed and compensated, because generally one carrier roller (3) always reliably remains on the carrier profile. There also results an improved guidance of chassis (1) and thus of cable or pipeline trolley (2) by the direct opposition of carrier roller (3) and guide roller (4). There also results an improved flow of force between guide rollers (4) and center plate (9) due to a smaller lateral offset of the force induction into the center plate. Finally, the weight reduction from a corresponding reduction of parts, and thus lower manufacturing costs, as well as lower running noise, can be mentioned as advantages. Furthermore, assembly and disassembly are simplified because of the lower number of required parts, and errors in assembly are avoided since the two carrier plates (6) and (7) are constructed identically to one another.

1-4. (canceled)

5. A cable or pipeline trolley (2) for traveling along a carrier rail, with at least one chassis (1) and with a carrier device (10) for cables or pipelines, as well as a central plate (9) that connects the carrier device (10) to the chassis (1), wherein at least two rectangular cavities (6) are arranged within the outer boundary of the central plate (9) symmetrical to the central axis of the central plate (9) and separated by a strut, characterized by the fact that at least two triangular cavities (7) are also arranged within the outer boundary of the central plate (9) symmetrically referring to the central axis of the central plate (9).

6. The cable or pipeline trolley (2) according to claim 5, characterized by the fact that the two inner cavities (6) are larger than the two outer cavities (7).

7. The cable or pipeline trolley (2) according to claim 6, characterized by the fact that the two rectangular cavities (6) have an essentially square shape with rounded corners.

8. The cable or pipeline trolley (2) according to claim 7, characterized by the fact that the central plate (9) contains a total of six cavities (6, 7, 8) that are arranged symmetrical to one another referring to the central axis (5) of the central plate (9) and two of which are intersected by this central axis (5).

9. The cable or pipeline trolley (2) according to claim 6, characterized by the fact that the central plate (9) contains a total of six cavities (6, 7, 8) that are arranged symmetrical to one another referring to the central axis (5) of the central plate (9) and two of which are intersected by this central axis (5).

10. The cable or pipeline trolley (2) according to claim 5, characterized by the fact that the two rectangular cavities (6) have an essentially square shape with rounded corners.

11. The cable or pipeline trolley (2) according to claim 5, characterized by the fact that the central plate (9) contains a total of six cavities (6, 7, 8) that are arranged symmetrical to one another referring to the central axis (5) of the central plate (9) and two of which are intersected by this central axis (5).
